(19) United States
(12) Patent Application Publication
(10) Pub. No.: US 2017/0359155 A1
(43) Pub. Date: Dec. 14, 2017

(54) USER TERMINAL, RADIO BASE STATION AND RADIO COMMUNICATION METHOD

(71) Applicant: NTT DOCOMO, INC., Tokyo (JP)

(72) Inventors: Hiroki Harada, Tokyo (JP); Kazuki Takeda, Tokyo (JP); Kazuaki Takeda, Tokyo (JP); Tooru Uchino, Tokyo (JP); Satoshi Nagata, Tokyo (JP)

(73) Assignee: NTT DOCOMO, INC., Tokyo (JP)

(21) Appl. No.: 15/547,862

(22) PCT Filed: Feb. 19, 2016
(86) PCT No.: PCT/JP2016/054788

§ 371 Date: Aug. 1, 2017

(30) Foreign Application Priority Data
Feb. 19, 2015 (JP) 2015-030843

(51) Int. Cl. H04L 5/00; H04W 72/04; H04W 72/02; H04W 74/08

(52) U.S. Cl. CPC H04L 5/001; H04W 72/048; H04W 72/0413; H04W 72/02; H04W 74/0866

(57) ABSTRACT

The present invention is designed so that communication can be performed adequately even when the number of component carriers (CCs) that can be configured in a user terminal is expanded and/or when CA is executed using unlicensed CCs. A user terminal communicates with a radio base station using carrier aggregation, and has a transmission section that transmits UL signals via each CC, and a control section that controls the transmission operations in the transmission section, and, when a plurality of CCs, including at least a first CC, which corresponds to a primary CC of an existing system, and a third CC, which is different from the first CC and a second CC that corresponds to a secondary CC of the existing system, are configured, the control section applies, to the third CC, random access operations that are different from those of the first and second CCs.

### TECHNICAL FIELD

The present invention relates to a user terminal, a radio base station and a radio communication method in next-generation mobile communication systems.

### BACKGROUND ART

In the UMTS (Universal Mobile Telecommunications System) network, the specifications of long term evolution (LTE) have been drafted for the purpose of further increasing high speed data rates, providing lower delays and so on (see non-patent literature 1). Successor system of LTE—referred to as “LTE-advanced” (also referred to as “LTE-A”)—have been under study for the purpose of achieving further broadbandization and increased speed beyond LTE, and the specifications thereof have been drafted as LTE Rel. 10 to 12.

The system band in LTE Rel. 10 to 12 includes at least one component carrier (CC), where the LTE system band constitutes one unit. Such bundling of a plurality of CCs into a wide band is referred to as “carrier aggregation” (CA). Also, in LTE Rel. 12 supports dual connectivity (DC), in which a user terminal communicates by using CCs that are controlled separately by different radio base stations (schedulers).

In CA/DC in the above-mentioned successor systems of LTE (LTE Rel. 10 to 12), the maximum number of CCs that can be configured per user terminal (UE) is limited to five. With LTE of Rel. 13 and later versions, which are more advanced successor systems of LTE, studies are in progress to mitigate the limit of the number of CCs that can be configured in a user terminal and to configure six or more CCs (for example, 32 CCs), in order to makes possible more flexible and faster communication.

The specifications of LTE Rel. 8 to 12 have been drafted assuming exclusive operations in frequency bands that are licensed to operators—that is, licensed bands. As licensed bands, for example, 800 MHz, 2 GHz and/or 1.7 GHz are used.

Furthermore, for future radio communication systems (Rel. 13 and later versions), a system (“LTE-U” (LTE Unlicensed)) to run LTE systems not only in frequency bands licensed to communications providers (operators) (licensed bands), but also in frequency bands where license is not required (unlicensed bands), is under study. In particular, a system (LAA: Licensed-Assisted Access) to run an unlicensed band assuming the presence of a licensed band is also under study. Note that systems that run LTE/LTE-A in unlicensed bands may be collectively referred to as “LAA.” A licensed band is a band in which a specific provider is allowed exclusive use, and an unlicensed band is a band which is not limited to a specific provider, and in which radio stations can be provided.

An unlicensed band may be run without even synchronization, coordination and/or cooperation between different operators and/or non-operators, and there is a threat that significant cross-interference is produced in comparison to a licensed band. Consequently, when an LTE/LTE-A system (LTE-U) is run in an unlicensed band, it is desirable if the LTE/LTE-A system operates by taking into account the cross-interference with other systems that run in unlicensed bands such as Wi-Fi, other operators' LTE-U, and so on. In order to prevent cross-interference in unlicensed bands, a study is in progress to allow an LTE-U base station/user terminal to perform “listening” before transmitting a signal and limit the transmission depending on the result of listening.

Also, for unlicensed bands, for example, the 2.4 GHz band and the 5 GHz band where Wi-Fi (registered trademark) and Bluetooth (registered trademark) can be used, and the 60 GHz band where millimeter-wave radars can be used are under study for use. Studies are in progress to use these unlicensed bands in small cells.

### CITATION LIST

### Non-Patent Literature

Non-Patent Literature 1: 3GPP TS 36. 300 “Evolved Universal Terrestrial Radio Access (E-UTRA) and Evolved Universal Terrestrial Radio Access Network (E-UTRAN); Overall Description; Stage 2”

### SUMMARY OF INVENTION

### Technical Problem

CA/DC for use in systems according to LTE Rel. 10 to 12 supports one primary cell (PCell) and maximum four secondary cells (SCells) as cells (CCs) to configure in a user terminal. In this way, in CA for existing systems (LTE Rel. 10 to 12), the number of CCs that can be configured per user terminal (UE) is limited to maximum five.

Meanwhile, when the number of CCs that can be configured in a user terminal is expanded to six or above (for example, 32 CCs) in more advanced successor systems of LTE (for example, LTE Rel. 13 and later versions), the load of the user terminal might grow following the increase of the number of CCs. For example, when additional CCs (“expanded CCs”) are configured in a user terminal as SCCs, the load that is required of the user terminal for the UL signal transmission operations for each SCell is likely to grow.

Also, when an unlicensed CC is configured in a user terminal as an SCC (for example, an as an expanded CC), cases might occur where, depending on the result of listening (the result of LBT), the user terminal is unable to transmit and receive signals with the unlicensed CC on a regular basis. Consequently, if the user terminal tries to perform transmission operations such as UL transmission for the unlicensed CC as for SCCs (SCells) of existing systems, there is a threat of disabling adequate communication.

The present invention has been made in view of the above, and it is therefore an object of the present invention to provide a user terminal, a radio base station and a radio communication method that enable adequate communication even when the number of CCs that can be configured in a user terminal is expanded from that of existing systems and/or when CA is executed using unlicensed CCs.

### Solution to Problem

One aspect of the present invention provides a user terminal that communicates with a radio base station by means of carrier aggregation using a plurality of component carriers (CCs), and this user terminal has a transmission section that transmits UL signals via each CC, and a control section that controls the transmission operations in the transmission section, and, in this user terminal, when a plurality of CCs, including at least a first CC, which corresponds to a primary CC of an existing system, and a third CC, which is different from the first CC and a second CC that corresponds to a secondary CC of the existing system, are configured, the control section applies, to the third CC, random access operations that are different from those of the first CC and the second CC.

### Advantageous Effects of Invention

According to the present invention, communication can be carried out adequately even when the number of CCs that can be configured in a user terminal is expanded from that of existing systems and/or when CA is executed using unlicensed CCs.

### BRIEF DESCRIPTION OF DRAWINGS

FIG. 1 is a diagram to explain an overview of carrier aggregation in successor systems of LTE;

FIG. 2 is a diagram to show an example of transmission control for use when listening (LBT) is used;

FIG. 3 is a diagram to explain CA using a PCC and SCCs of an existing system, and an unlicensed CC;

FIG. 4 is a diagram to show an example of a case where unlicensed CCs are configured as SCCs;

FIG. 5 is a diagram to show an example of carrier aggregation according to the present embodiment;

FIG. 6 provide diagrams to show an example of carrier aggregation according to the present embodiment;

FIG. 7 is a diagram to explain random access procedures;

FIG. 8 is a diagram to explain random access operations according to the present embodiment;

FIG. 9 is a diagram to show an example of transmission of identification information, transmitted from each user terminal, according to the present embodiment;

FIG. 10 provide diagrams to show other examples of transmission of identification information, transmitted from each user terminal, according to the present embodiment;

FIG. 11 is a diagram to show an example of a schematic structure of a radio communication system according to the present embodiment;

FIG. 12 is a diagram to show an example of an overall structure of a radio base station according to the present embodiment;

FIG. 13 is a diagram to show an example of a functional structure of a radio base station according to the present embodiment;

FIG. 14 is a diagram to show an example of an overall structure of a user terminal according to the present embodiment; and

FIG. 15 is a diagram to show an example of a functional structure of a user terminal according to the present embodiment.

### DESCRIPTION OF EMBODIMENTS

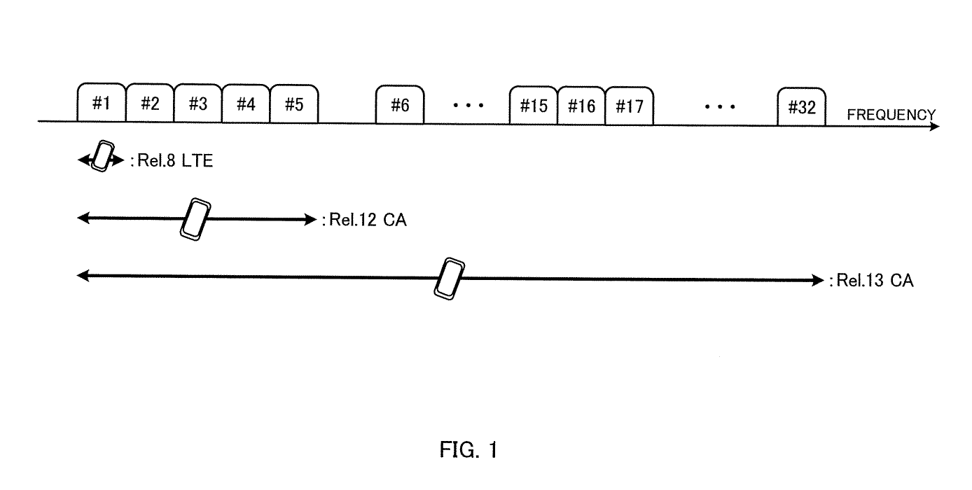

FIG. 1 is a diagram to explain carrier aggregation (CA). As shown in FIG. 1, in CA of existing systems (up to LTE Rel. 12), maximum five component carriers (CCs) (CC #1 to CC #5), where the system band of LTE Rel. 8 constitutes one unit, are bundled. That is, in carrier aggregation up to LTE Rel. 12, the number of CCs that can be configured in a user terminal (UE: User Equipment) is limited to maximum five (one primary cell and maximum four secondary cells).

Meanwhile, in more advanced successor systems of LTE (for example, LTE Rel. 13 and later versions), a study is in progress to soften the limit of the number of CCs that can be configured per user terminal, and use enhanced carrier aggregation (CA enhancement), in which six or more CCs (cells) are configured. For example, as shown in FIG. 1, when 32 CCs (CC #1 to CC #32) are bundled, a bandwidth of maximum 640 MHz can be secured. In this way, more flexible and faster radio communication is expected to be made possible by increasing the number of CCs that can be configured in a user terminal.

Furthermore, for more advanced successor systems of LTE (for example, Rel. 13 and later versions), systems to run LTE systems not only in frequency bands licensed to communications providers (operators) (licensed bands), but also in frequency bands where license is not required (unlicensed bands), are under study.

The premise of existing LTE/LTE-A is that it is run in licensed bands, and therefore each operator is allocated a different frequency band. However, unlike a licensed band, an unlicensed band is not limited to use by a specific provider. When run in an unlicensed band, LTE may be carried out without even synchronization, coordination and/or cooperation between different operators and/or non-operators. In this case, a plurality of operators and/or systems share and use the same frequency in the unlicensed band, and therefore there is a threat of producing cross-interference.

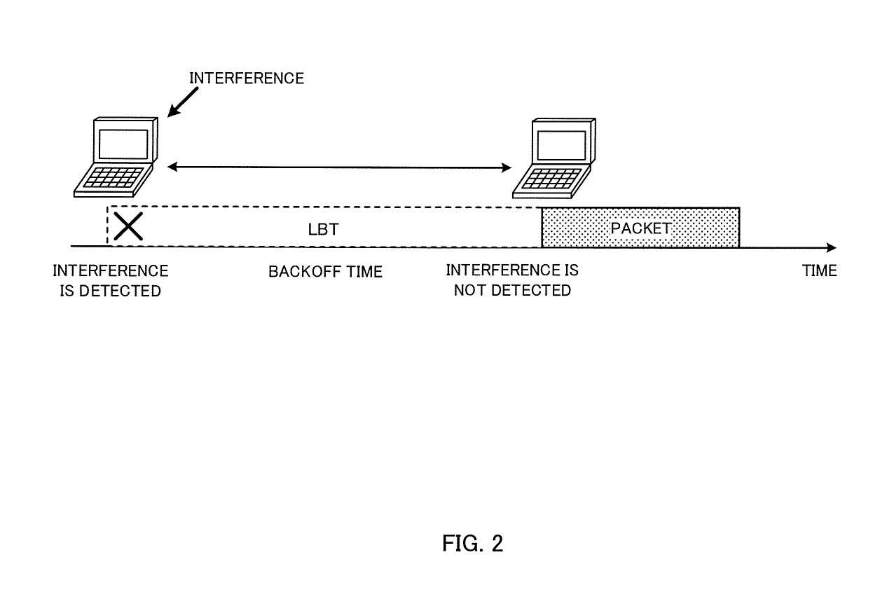

So, in Wi-Fi systems that are run in unlicensed bands, carrier sense multiple access/collision avoidance (CSMA/CA), which is based on the mechanism of LBT (Listen Before Talk), is employed. To be more specific, for example, a method, whereby each transmission point (TP), access point (AP), Wi-Fi terminal (STA: Station) and so on perform “listening” (CCA: Clear Channel Assessment) before carrying out transmission, and carries out transmission only when there is no signal beyond a predetermined level, is used. When there is a signal to exceed a predetermined level, a waiting time (backoff time) is provided, which is determined on a random basis, and, following this, listening is performed again (see FIG. 2).

So, for LTE/LTE-A systems that are run in unlicensed bands (for example, LAA), too, a study is in progress to use transmission control based on the result of listening. Note that, in the present description, “listening” refers to the operation which a radio base station and/or a user terminal performs before transmitting signals in order to check whether or not signals to exceed a predetermined level (for example, predetermined power) are being transmitted from other transmission points. Also, this “listening” performed by radio base stations and/or user terminals may be referred to as “LBT” (Listen Before Talk), “CCA” (Clear Channel Assessment), and so on.

For example, a radio base station and/or a user terminal perform listening (LBT) before transmitting signals in an unlicensed band cell, and checks whether other systems (for example, Wi-Fi) and/or other operators are communicating. If, as a result of listening, the received signal intensity from other systems and/or other LAA transmission points is equal to or lower than a predetermined value, the radio base station and/or the user terminal judge that the channel is in the idle state (LBT_idle) and transmit signals. On the other hand, if, as a result of listening, the received signal intensity from other systems and/or other LAA transmission points is greater than the predetermined value, the radio base station and/or the user terminal judge that the channel is in the busy state (LBT_busy), and limit signal transmission. The transmission control may include making a transition to another carrier by way of DFS (Dynamic Frequency Selection), applying transmission power control (TPC), or holding (stopping) transmission.

In this way, when LBT is applied to communication in an LTE/LTE-A system (for example, LAA) that runs in an unlicensed band, it becomes possible to reduce interference with other systems and so on.

Now, as shown in FIG. 1, expanding the number of CCs is effective to widen the band in carrier aggregation (LAA: License-Assisted Access) between licensed bands and unlicensed bands. For example, five licensed band CCs (=100 MHz) and fifteen unlicensed band CCs (=300 MHz) are bundled, and a bandwidth of 400 MHz can be secured.

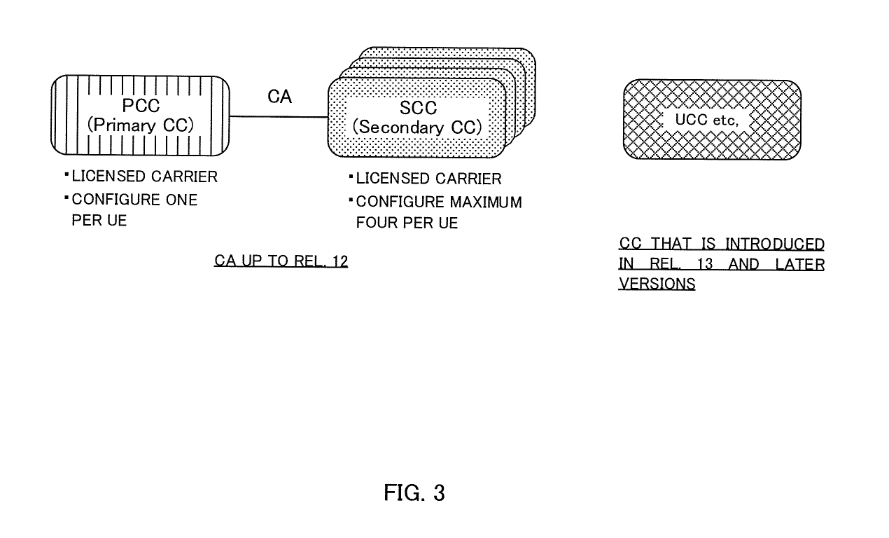

Meanwhile, when the number of CCs that can be configured in a user terminal is expanded, and/or when CA is executed using an unlicensed CC (UCC), how to configure the expanded CCs and/or the unlicensed CC (UCC) and how to control the user terminal's operations is the problem (see FIG. 3).

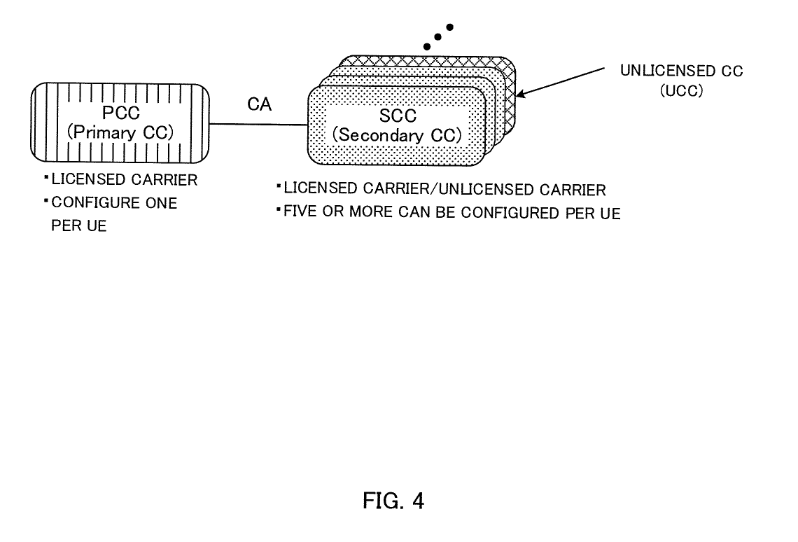

For example, as shown in FIG. 4, it may be possible to execute CA, assuming that an unlicensed band CC (UCC) is a secondary cell (SCC) of existing systems. Note that the unlicensed CC (UCC) in FIG. 4 may be configured as an expanded CC as well.

However, the transmission/non-transmission (ON/OFF) state in an unlicensed cell changes dynamically because executing LBT upon transmission is the premise of unlicensed carriers. Consequently, there is a threat that user terminals are unable to transmit signals on a regular basis as in the PCC or in SCCs in the activated state. On the other hand, in UCCs, although signals are not transmitted on a regular basis, signals start being transmitted or received soon depending on the result of LBT, so that it is necessary to control user terminals to be able to transmit and receive these signals. In this case, the user terminal operations required by UCCs may be different from those required by existing SCCs.

Also, since an unlicensed carrier allows co-presence with other systems, the quality varies significantly compared to a licensed carrier, and the reliability of communication is highly likely to deteriorate. Consequently, in LAA, it may be possible to support the use of unlicensed carriers by using licensed carriers (for example, by reporting LBT results by using a licensed carrier). In this case, the user terminal operations for unlicensed CCs and existing SCCs may be different.

So, the present inventors have come up with the idea of operating/controlling user terminals differently between expanded CCs and unlicensed CCs, and existing PCCs and SCCs. Also, the present inventors have come up with the idea of configuring a new CC that is neither a PCC nor an SCC, and configuring/reporting this CC in a user terminal, so as to enable the user terminal to distinguish the CC (for example, a UCC), to which different operations/control are applied, from the PCCs and SCCs of existing systems (Rel. 10 to 12).

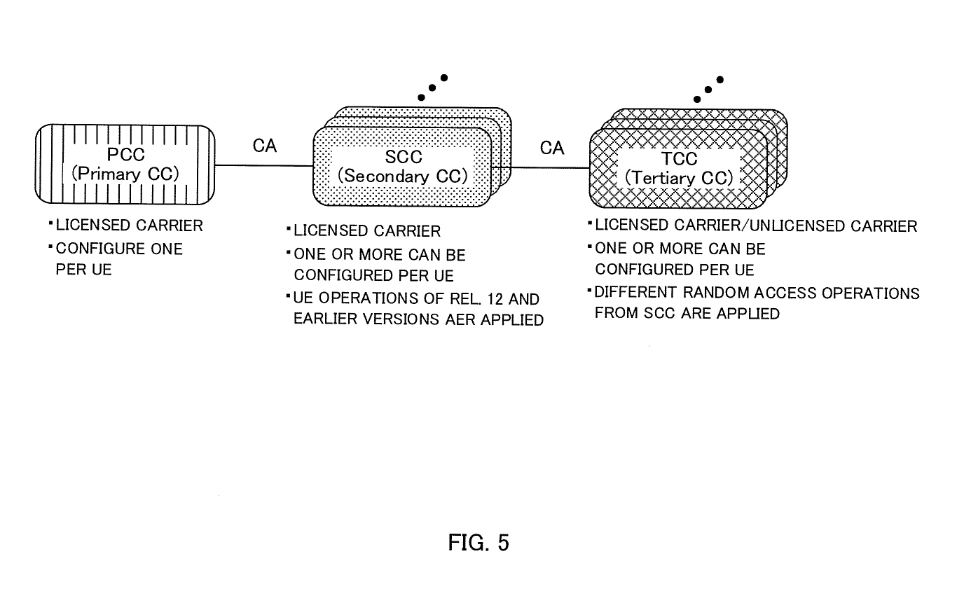

To be more specific, the present inventors have come up with the idea of defining expanded CCs and/or UCCs differently from existing PCCs and SCCs, and applying different control/operations from those of existing SCCs (see FIG. 5). In this description, a CC, to which different control/operations from those of PCCs and SCCs in existing systems (Rel. 10 to Rel. 12) are applied, will be referred to as a “TCC” (Tertiary CC), a “TCell,” a “third CC” or a “third cell” (hereinafter “TCC”). A TCC can be constituted by a licensed CC and/or an unlicensed CC.

A user terminal, in which a TCC is configured, can apply different control/operations (for example, random access operations) to the TCC, from those for SCCs (see FIG. 5). For example, a user terminal establishes synchronization with a TCC by following different random access procedures from those of PCCs and SCCs.

By this means, it is possible to avoid the situation where, in a TCC, transmitting/receiving processes to require a physical random access channel (PRACH) are performed even though listening has made it clear that there is no interference, which then makes it possible to perform communication processes for establishing initial connection and synchronization, for resuming communication, and so on, adequately.

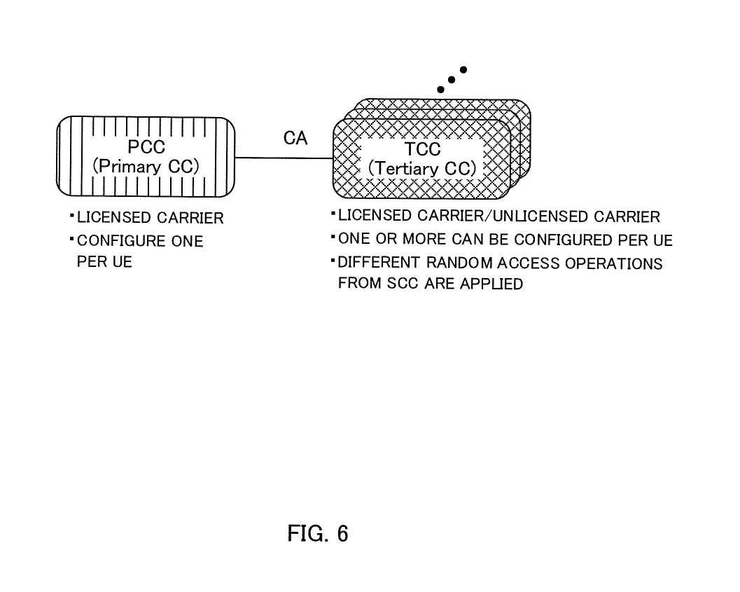

Now, the present embodiment will be described below in detail. Note that, although cases will be described in the following description where one or more licensed CC and/or unlicensed CCs are configured as TCCs, this is by no means limiting. For example, TCCs can be constituted by unlicensed CCs alone. Also, with the present embodiment, it is equally possible to configure a PCC (PCell) and a TCC (TCell) in a user terminal and execute CA/DC (that is, SCCs (SCells) are not configured) (see FIG. 6). Also, it is possible to configure five or more CCs in a user terminal as SCCs (SCells).

### First Example

The first example assumes that, in the above TCCs (when there are UL Cells), too, random access procedures are executed in order to establish UL timings. According to the first example, when a user terminal executes random access procedures via a TCC (TCell), the user terminal transmits identification information for identifying the subject terminal, by using predetermined radio resources, without transmitting random access preambles.

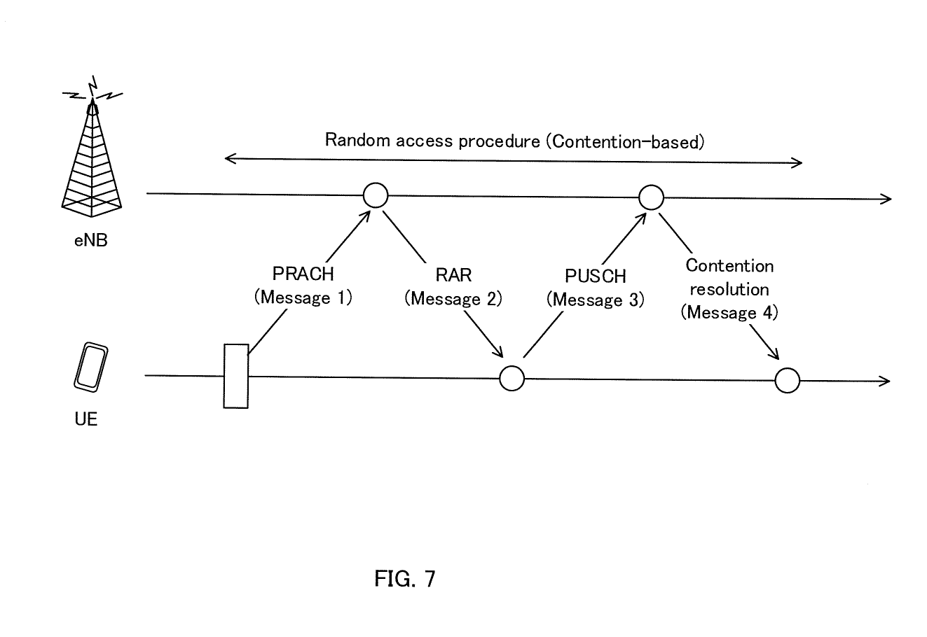

In existing LTE systems, random access is made by transmitting a physical random access channel (PRACH) on the uplink when establishing initial connection, when establishing synchronization, when resuming uplink communication, and so on. FIG. 7 shows an overview of what is commonly referred to as “contention-based random access” (CERA) in random access.

In contention-based random access, a user terminal, when triggered (for example, when resuming UL data), transmits a random access preamble in the nearest subframe that is capable of transmitting a PRACH. To be more specific, the user terminal transmits a preamble, which is selected randomly from a plurality of random access preambles (contention preambles) prepared within the cell, by using a PRACH. In this case, there is a possibility that the same random access preamble may be used between user terminals and create contention.

To be more specific, as shown in FIG. 7, random access is comprised of four steps. First, a user terminal UE transmits a random access preamble (PRACH) by using a PRACH resource that is configured in the residing cell (message (Msg) 1). A radio base station eNB, upon detecting the random access preamble, transmits a random access response (RAR) in response to that (message 2). After having transmitted the random access preamble, the user terminal UE tries to receive message 2 for a predetermined period. When the user terminal UE fails to receive message 2, the user terminal UE raises the transmission power of the PRACH and transmits (retransmits) message 1 again. Note that increasing the transmission power when retransmitting signals is also referred to as “power ramping.” Note that the user terminal UE compares between the transmission power that is achieved by power-ramping and the maximum transmission power P_{CMAX,c} of the serving cell c where the PRACH is transmitted, and transmits the PRACH by using the smaller transmission power between the two. Consequently, even when power-ramping is applied, transmission power to exceed P_{CMAX,c} may not be achieved.

The user terminal UE, when receiving the random access response, transmits a data signal (message 3) by using the physical uplink shared channel (PUSCH) that is specified by an uplink grant included in the random access response. The radio base station eNB, upon receiving message 3, transmits a contention resolution message to the user terminal UE (message 4). The user terminal UE identifies the radio base station eNB by establishing synchronization using messages 1 to 4, and thereupon finishes the random access procedures and establishes a connection.

Note that the transmission of a random access preamble (message 1) using a PRACH is also referred to as the transmission of a PRACH, and the receipt of a random access response (message 2) using a PRACH is also referred as the receipt of a PRACH.

By contrast with this, if a user terminal applies random access procedures to an unlicensed band (TCC) in the same way as to the PCC/SCCs, the transmission and receipt of signals is limited depending on the result of LBT, and, consequently, it takes time until the execution of random access procedures is started (for example, until message 1—that is, a random access preamble—starts being transmitted). Furthermore, in the TCC, although LBT has made it clear that no data is being transmitted from nearby transmitting devices, steps that are not necessarily required are nevertheless taken, such as transmitting a random access preamble and receiving a signal (message 2) in response to this random access preamble.

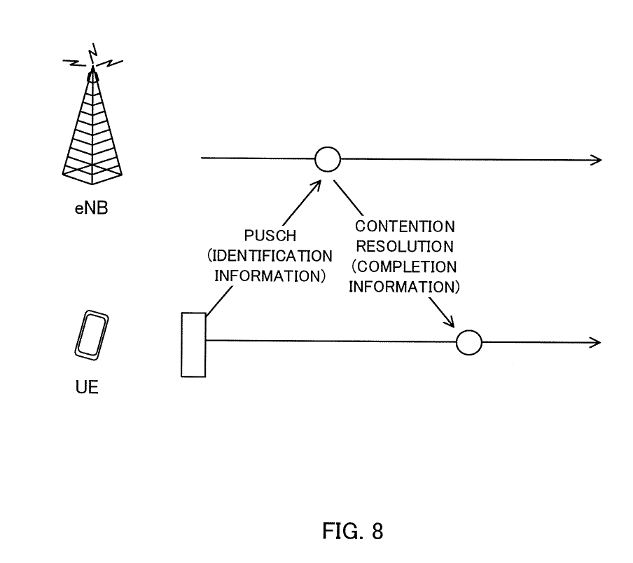

So, according to the first example, when a user terminal is triggered to establish initial connection or synchronization, or to resume communication, the user terminal transmits identification information for identifying the subject terminal, not a random access preamble, via the PUSCH (see FIG. 8). The identification information which the user terminal transmits using the PUSCH may be made equivalent to random access message 3 in existing systems, may be an enhanced version of this message 3, or may be information that is defined anew.

The radio base station can transmit information about resources (PUSCH resource) that can be used to transmit the identification information to the user terminal in advance by using, for example, broadcast or dedicated signaling. Also, the radio base station can report the information about PUSCH resources to the user terminal by using the PCC/SCCs. Based on the information about PUSCH resources reported, the user terminal can allocate the identification information to the PUSCH and transmit this to the radio base station. In this case, it is also possible to report the identification information by selecting a predetermined PUSCH resource from the PUSCH resources that are reported.

Also, if RRC (Radio Resource Control) is not configured, the user terminal may a CCCH (Common Control Channel) SDU (Service Date Unit) in the identification information, and, if RRC connection is established, the user terminal may include a C-RNTI (Cell-Radio Network Temporary Identifier) MAC (Media Access Control) CE (Control Element) in the identification information. Note that the C-RNTI which the user terminal reports at this time may be one that is assigned to the PCC/SCCs, or may be one that is specially assigned to the TCC, and any identifier may suffice as long as the identifier can identify this user terminal.

Also, although, usually, a TC-RNTI (Temporary C-RNTI) or a C-RNTI is used for the scrambling of identification information, according to this first example, it is possible to scramble identification information by using an RA-RNTI (Random Access-Radio Network Temporary Identifier). Although identifiers that have been set forth heretofore are meant to be used here, apart from the RA-RNTI, any identifier that is uniquely specified by, for example, the transmission timing and frequency of the PUSCH, the resource location, the bandwidth and so on may be used.

Upon receiving the PUSCH from the user terminal, the radio base station performs the user terminal identification process, the contention resolution process and so on, and then transmits completion information, which indicated that these are complete, to the user terminal (see FIG. 8). The completion information which the radio base station transmits may be made equivalent to random access message 4 in existing systems, may be an enhanced version of this message 4, or may be information that is defined anew. The completion information does not necessarily have to be transmitted in the TCC, which is an unlicensed carrier, and may be transmitted in a licensed carrier as well. In this case, the licensed carrier to report the completion signal may be specified in advance by, for example, a higher layer (for example, RRC). Also, although a UL grant can be reported if RRC connection is already established, it is more likely that a UL grant alone is not sufficient for contention resolution, so that it is possible to newly set forth a special signal (contention resolution MAC CE) and transmit this. The content of this contention resolution MAC CE may be, for example, a signal that contains this user equipment's identifier (for example, a C-RNTI MAC CE). When this is reported in a licensed carrier, the identifier associated with this licensed carrier may be transmitted.

Also, although contention-based random access has been described above as an example, non-contention-based random access is equally applicable. In this case, the radio base station allocates resources to use for PUSCH transmission (non-contention, time or frequency resources) to a user terminal in advance, and the user terminal makes uplink transmission using these resources. In this case, the identifier which the user terminal includes in the PUSCH transmission may be a special one unrelated to contention-based random access.

According to this first example, in a TCC, which is an unlicensed carrier, listening makes it clear if no data is transmitted from nearby transmitting devices (user terminals and/or the like) in the same frequency, so that it is possible to skip unnecessary transmitting/receiving processes such as transmitting a random access preamble, receiving a response to this, and so on. By this means, communication can be carried out adequately even when the number of CCs that can be configured in a user terminal is expanded from that of existing systems and/or when CA is executed using unlicensed CCs.

### Second Example

Next, a second example will be described. A characteristic of the second example lies in transmission of the above-noted identification information, and the identification information is transmitted in one of a plurality of consecutive subframes.

In existing random access procedures, messages 1 and 2 are transmitted in one subframe (1 ms). Skipping these messages 1 and 2 may result in a collision with PUSCH transmission from other user terminals, and there is a possibility that these colliding users lose data. In a TCC, a plurality of user terminals that belong to the same cell may perform listening at the same timing, and, in this case, when a listening result to show that no interference is detected is yielded, these multiple user terminals transmit identification information by using resources in desired portions of the PUSCH. This may result in a case where contention is created between the resources where the identification information is allocated. The second example is applicable to this case.

Also, although, with the above-described first example, resources where identification information is allocated can be reported in advance by way of broadcast or dedicated signaling, if a resource area for allocating identification information is shared by a plurality of user terminals to improve the efficiency of the use of resources, contention of resources may be created, as in the above-described case. The second example may be applied to the first example in this case.

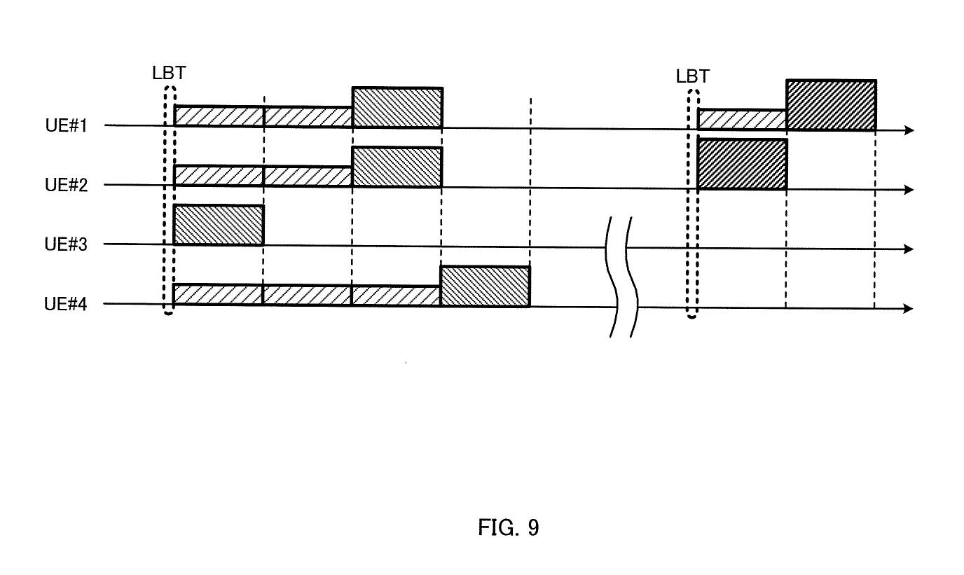

With this second example, for example, as shown in FIG. 9, when listening is complete (when LBT is OK), identification information is transmitted in one of a plurality of consecutive subframes. Referring to FIG. 9, user terminals UE #1 to #4 each transmit identification information over a number of subframes, where the number of determined randomly in each terminal. To be more specific, based on the number of subframes “3,” which is determined randomly, user terminals UE #1 and #2 transmit identification information in each subframe over three consecutive subframes. User terminal UE #3 transmits identification information in one subframe based on the number of subframes “1,” which is determined randomly. User terminal UE #4 transmits identification information in each subframe over four consecutive subframes, based on the number of subframes “4,” which is determined randomly.

Note that, in subframes other than the last subframe, user terminals UE #1 to #4 transmit identification information with low transmission power, compared to the transmission power of the last subframe. In this way, by continuing transmitting identification information until the last subframe, it is possible to prevent other transmitting devices from interrupting and starting transmission after listening is complete. Note that when the number of subframes that is determined randomly is 1, identification information is not transmitted with low transmission power (see, for example, user terminal UE #3 in FIG. 9). Also, when transmission is made with low transmission power, the data that is transmitted may be the same as the data that is transmitted with high transmission power, or any signals may be transmitted, including random sequences, padding, and so on. Note that the value of low transmission power may be reported from the radio base station in advance. As for the method of reporting, a method of reporting absolute values may be used. For example, relative values (for example, percentage) with respect to the cell's maximum transmission power, the user terminal's maximum transmission power or the transmission power value to use in the last subframe and so on may be reported from the radio base station.

When transmission of identification information is not complete—for example, when the last subframe overlaps another user terminal's last subframe (when the same number of subframes is determined randomly)—the radio base station may be unable to identify the user terminal and complete contention resolution. In this case, completion information is not transmitted from radio base station to the user terminal, and the user terminal judges that random access has failed. The user terminal, judging that random access has failed, applies ramping (raises the transmission power) and transmits the identification information again, after the next listening is complete.

To be more specific, referring to FIG. 9, user terminals UE #1 and UE #2 decide upon the same number of subframes (three subframes), and transmit identification information based on this number of subframes. As a result, one or both of the user terminals may fail random access. Each of user terminal UEs #1 and #2, when judging that random access has failed, determines the number of subframes again, in response to completion of listening. Here, user terminal UE #1 determines on the number of subframes 2, and user terminal UE #2 determines on the number of subframes 1.

User terminal UE #1 transmits identification information over two subframes, but transmits the identification information with ramped power in the last subframe (the second subframe). Meanwhile, user terminal UE #2 transmits identification information with ramped power in the first subframe. By means of these processes by user terminal UEs #1 and #2, the radio base station can receive the identification information from user terminal UE #2 properly in the first subframe, and perform processes in accordance with this identification information. Similarly, the radio base station can receive the identification information from user terminal UE #1 properly in the second subframe, and perform processes in accordance with this identification information.

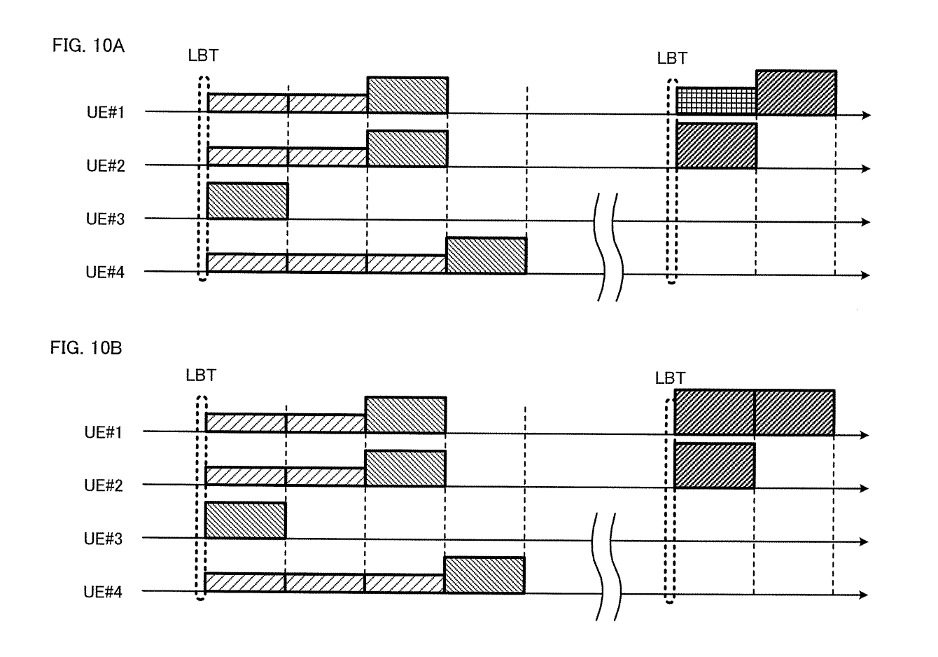

When the user terminal applies ramping after failing random access, the user terminal may, for example, apply the ramping step used in the ramping (the value of increase or the rate of increase, indicating how much the transmission power is raised in the next transmission) to all subframes. In this case, as shown in the case of user terminal UE #1 in FIG. 10A, the transmission power is raised in the subframe before the last subframe as well. Also, given that the number of subframes is determined, it is equally possible to transmit identification information with raised transmission power in all of these subframes (see FIG. 10B). Note that the above-noted ramping step may be reported in advance from the radio base station. As for the values to use in ramping, values that are configured in the PCC/SCCs may be reported, or special values may be reported from the radio base station to the TCC. Also, upon retransmission, it may be possible to increase the number of subframes to transmit with high transmission power, like the last subframe, among the consecutive subframes, so as to make it easier to avoid contention.

As described above, according to the this second example, even when contention of resources is created among a plurality of user terminals, given that the number of subframes is determined randomly, desired data—for example, identification information—can be transmitted adequately unless the last subframes assume the same timing. Also, even when random access fails, the subframes are determined randomly again, so that it is possible to retransmit the data (identification information) effectively. Also, upon retransmission, ramping can be applied. By this means, communication can be carried out adequately even when the number of CCs that can be configured in a user terminal is expanded from that of existing systems and/or when CA is executed using unlicensed CCs.

Note that, although a case has been described above where a PCC/SCC and a TCC are aggregated and used, it is equally possible to apply the same control when a user terminal connects with a TCC alone (stand-alone).

(Structure of Radio Communication System)

Now, the structure of the radio communication system according to an embodiment of the present invention will be described below. In this radio communication system, the radio communication methods according to the embodiments of the present invention are employed. Note that the radio communication methods of the above-described embodiments may be applied individually or may be applied in combination.

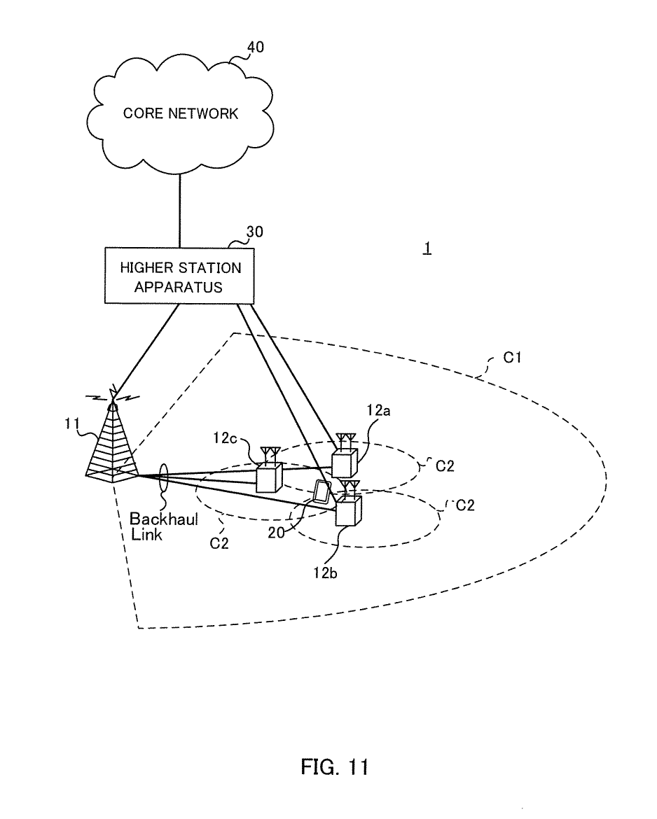

FIG. 11 is a diagram to show an example of a schematic structure of a radio communication system according to an embodiment of the present invention. Note that the radio communication system shown in FIG. 11 is a system to incorporate, for example, an LTE system, super 3G, an LTE-A system and so on. In this radio communication system, carrier aggregation (CA) and/or dual connectivity (DC) to bundle a plurality of component carriers (PCC, SCC, TCC, etc.) into one can be used. Note that this radio communication system may be referred to as “IMT-Advanced,” or may be referred to as “4G,” “5G,” “FRA” (Future Radio Access) and so on.

The radio communication system 1 shown in FIG. 11 includes a radio base station 11 that forms a macro cell C1, and radio base stations 12a to 12c that form small cells C2, which are placed within the macro cell C1 and which are narrower than the macro cell C1. Also, user terminals 20 are placed in the macro cell C1 and in each small cell C2.

The user terminals 20 can connect with both the radio base station 11 and the radio base stations 12 (12a to 12c). The user terminals 20 may use the macro cell C1 and the small cells C2, which use different frequencies, at the same time, by means of CA or DC. Also, the user terminals 20 can execute CA or DC by using at least six or more CCs (cells). For example, it is possible to configure, in the user terminals, the macro cell C1 as the PCell (PCC) and the small cells C2 as SCells (SCCs) and/or TCells (TCCs). Also, for TCCs, licensed bands and/or unlicensed bands can be configured.

Between the user terminals 20 and the radio base station 11, communication can be carried out using a carrier of a relatively low frequency band (for example, 2 GHz) and a narrow bandwidth (referred to as, for example, an “existing carrier,” a “legacy carrier” and so on). Meanwhile, between the user terminals 20 and the radio base stations 12, a carrier of a relatively high frequency band (for example, 3.5 GHz, 5 GHz and so on) and a wide bandwidth may be used, or the same carrier as that used in the radio base station 11 may be used. Between the radio base station 11 and the radio base stations 12 (or between two radio base stations 12), wire connection (optical fiber, the X2 interface, etc.) or wireless connection may be established.

The radio base station 11 and the radio base stations 12 are each connected with a higher station apparatus 30, and are connected with a core network 40 via the higher station apparatus 30. Note that the higher station apparatus 30 may be, for example, an access gateway apparatus, a radio network controller (RNC), a mobility management entity (MME) and so on, but is by no means limited to these. Also, each radio base station 12 may be connected with higher station apparatus 30 via the radio base station 11.

Note that the radio base station 11 is a radio base station having a relatively wide coverage, and may be referred to as a “macro base station,” a “central node,” an “eNB” (eNodeB), a “transmitting/receiving point” and so on. Also, the radio base stations 12 are radio base stations having local coverages, and may be referred to as “small base stations,” “micro base stations,” “pico base stations,” “femto base stations,” “HeNBs” (Home eNodeBs), “RRHs” (Remote Radio Heads), “transmitting/receiving points” and so on. Hereinafter the radio base stations 11 and 12 will be collectively referred to as a “radio base station 10,” unless specified otherwise. The user terminals 20 are terminals to support various communication schemes such as LTE, LTE-A and so on, and may be either mobile communication terminals or stationary communication terminals.

In the radio communication system, as radio access schemes, OFDMA (Orthogonal Frequency Division Multiple Access) is applied to the downlink, and SC-FDMA (Single-Carrier Frequency Division Multiple Access) is applied to the uplink. OFDMA is a multi-carrier communication scheme to perform communication by dividing a frequency band into a plurality of narrow frequency bands (subcarriers) and mapping data to each subcarrier. SC-FDMA is a single-carrier communication scheme to mitigate interference between terminals by dividing the system band into bands formed with one or continuous resource blocks per terminal, and allowing a plurality of terminals to use mutually different bands. Note that the uplink and downlink radio access schemes are by no means limited to the combination of these.

In the radio communication system 1, a downlink shared channel (PDSCH: Physical Downlink Shared CHannel), which is used by each user terminal 20 on a shared basis, a broadcast channel (PBCH: Physical Broadcast CHannel), downlink L1/L2 control channels and so on are used as downlink channels. User data, higher layer control information and predetermined SIBs (System Information Blocks) are communicated in the PDSCH. Also, MIBs (Master Information Blocks) and so on are communicated by the PBCH.

The downlink L1/L2 control channels include a PDCCH (Physical Downlink Control CHannel), an EPDCCH (Enhanced Physical Downlink Control CHannel), a PCFICH (Physical Control Format Indicator CHannel), a PHICH (Physical Hybrid-ARQ Indicator CHannel) and so on. Downlink control information (DCI) including PDSCH and PUSCH scheduling information is communicated by the PDCCH. The number of OFDM symbols to use for the PDCCH is communicated by the PCFICH. HARQ delivery acknowledgement signals (ACKs/NACKs) in response to the PUSCH are communicated by the PHICH. The EPDCCH may be frequency-division-multiplexed with the PDSCH (downlink shared data channel) and used to communicate DCI and so on, like the PDCCH.

Also, as downlink reference signals, cell-specific reference signals (CRSs), channel state measurement reference signals (CSI-RSs: Channel State Information-Reference Signals), user-specific reference signals (DM-RSs: Demodulation Reference Signals) for use for demodulation and others are included.

In the radio communication system 1, an uplink shared channel (PUSCH: Physical Uplink Shared CHannel), which is used by each user terminal 20 on a shared basis, an uplink control channel (PUCCH: Physical Uplink Control CHannel), a random access channel (PRACH: Physical Random Access CHannel) and so on are used as uplink channels. User data and higher layer control information are communicated by the PUSCH.

Also, downlink radio quality information (CQI: Channel Quality Indicator), delivery acknowledgment signals (HARQ-ACKs) and so on are communicated by the PUCCH. By means of the PRACH, random access preambles (RA preambles) for establishing connections with cells are communicated.

<Radio Base Station>

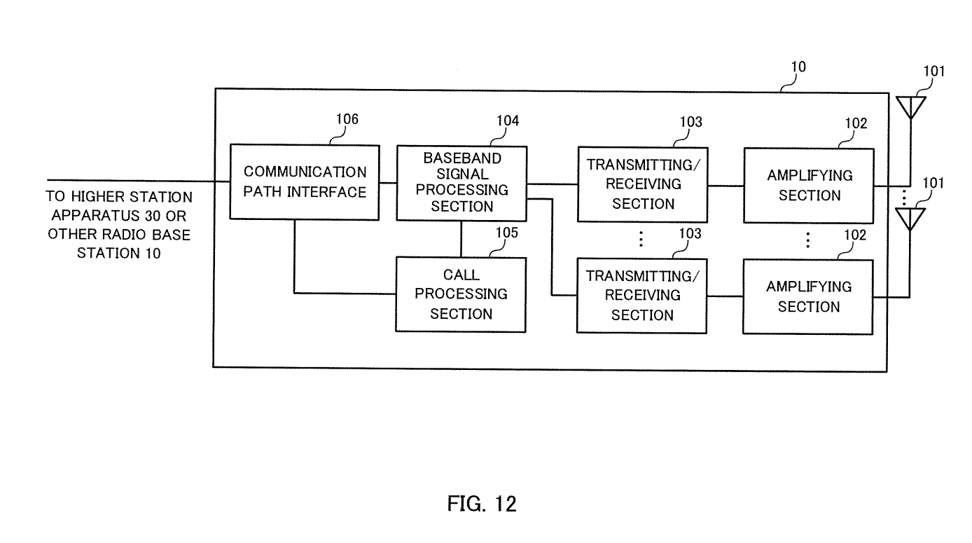

FIG. 12 is a diagram to show an example of an overall structure of a radio base station according to one embodiment of the present invention. A radio base station 10 has a plurality of transmitting/receiving antennas 10, amplifying sections 102, transmitting/receiving sections 103, a baseband signal processing section 104, a call processing section 105 and a communication path interface 106. Note that the transmitting/receiving sections 103 are comprised of transmission sections and receiving sections.

User data to be transmitted from the radio base station 10 to a user terminal 20 on the downlink is input from the higher station apparatus 30 to the baseband signal processing section 104, via the communication path interface 106.

In the baseband signal processing section 104, the user data is subjected to a PDCP (Packet Data Convergence Protocol) layer process, user data division and coupling, RLC (Radio Link Control) layer transmission processes such as RLC retransmission control, MAC (Medium Access Control) retransmission control (for example, an HARQ (Hybrid Automatic Repeat reQuest) transmission process), scheduling, transport format selection, channel coding, an inverse fast Fourier transform (IFFT) process and a precoding process, and the result is forwarded to each transmitting/receiving section 103. Furthermore, downlink control signals are also subjected to transmission processes such as channel coding and an inverse fast Fourier transform, and forwarded to each transmitting/receiving section 103.

Each transmitting/receiving section 103 converts baseband signals that are pre-coded and output from the baseband signal processing section 104 on a per antenna basis, into a radio frequency band. The radio frequency signals having been subjected to frequency conversion in the transmitting/receiving sections 103 are amplified in the amplifying sections 102, and transmitted from the transmitting/receiving antennas 101.

For example, the transmitting/receiving sections 103 can transmit information about CCs that execute CA (for example, information about a CC to serve as a TCC, and so on). Also, the transmitting/receiving sections 103 can report receiving operation and/or random access operation commands in TCCs via downlink control information (PDCCH/EPDCCH) of the PCC and/or SCCs, to the user terminals. For the transmitting/receiving sections 103, transmitters/receivers, transmitting/receiving circuits or transmitting/receiving devices that can be described based on common understanding of the technical field to which the present invention pertains can be used.

Meanwhile, as for uplink signals, radio frequency signals that are received in the transmitting/receiving antennas 101 are each amplified in the amplifying sections 102. Each transmitting/receiving section 103 receives uplink signals amplified in the amplifying sections 102. The received signals are converted into the baseband signal through frequency conversion in the transmitting/receiving sections 103 and output to the baseband signal processing section 104.

In the baseband signal processing section 104, user data that is included in the uplink signals that are input is subjected to a fast Fourier transform (FFT) process, an inverse discrete Fourier transform (IDFT) process, error correction decoding, a MAC retransmission control receiving process, and RLC layer and PDCP layer receiving processes, and forwarded to the higher station apparatus 30 via the communication path interface 106. The call processing section 105 performs call processing such as setting up and releasing communication channels, manages the state of the radio base stations 10 and manages the radio resources.

The communication path interface section 106 transmits and receives signals to and from the higher station apparatus 30 via a predetermined interface. Also, the communication path interface 106 transmits and receives signals to and from neighboring radio base stations 10 (backhaul signaling) via an inter-base station interface (for example, optical fiber, the X2 interface, etc.).

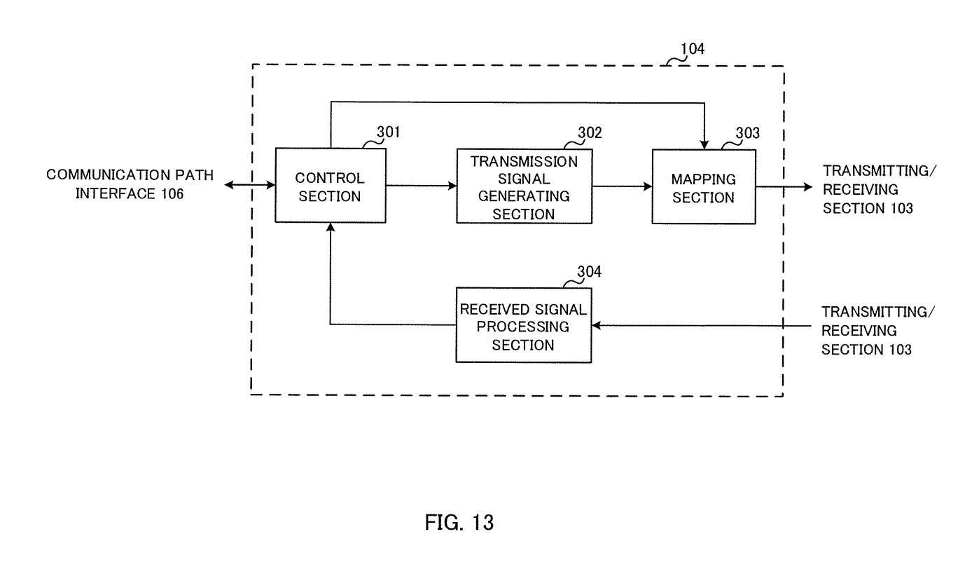

FIG. 13 is a diagram to show an example of a functional structure of a radio base station according to the present embodiment. Note that, although FIG. 13 primarily shows functional blocks that pertain to characteristic parts of the present embodiment, the radio base station 10 has other functional blocks that are necessary for radio communication as well. As shown in FIG. 13, the baseband signal processing section 104 has a control section (scheduler) 301, a transmission signal generating section (generating section) 302, a mapping section 303 and a received signal processing section 304.

The control section (scheduler) 301 controls the scheduling of (for example, allocates resources to) downlink data signals that are transmitted in the PDSCH and downlink control signals that are communicated in the PDCCH and/or the EPDCCH. Furthermore, the control section (scheduler) 301 also controls the scheduling of system information, synchronization signals, paging information, CRSs, CSI-RSs and so on. For example, for an unlicensed CC (for example, a TCC), the control section 301 controls the transmission of DL signals based on the result of DL LBT. When LBT is executed in the unlicensed band (TCC), the control section 301 may control the result of this LBT to be reported to the user terminal in a licensed band (the PCC and/or an SCC). Also, in the TCC, the control section 301 can configure the transmission cycle of downlink reference signals (for example, the CRS, the CSI-RS, etc.) longer than in SCCs, or configure the transmission cycle shorter than in SCCs.

Also, the control section 301 controls the scheduling of uplink reference signals, uplink data signals that are transmitted in the PUSCH, uplink control signals that are transmitted in the PUCCH and/or the PUSCH, random access preambles that are transmitted in the PRACH, and so on. For example, in random access operations, when a PUSCH is received from a user terminal, the control section performs the user terminal identification process, the contention resolution process and so on, and transmits completion information to the user terminal (see FIG. 8). When a PUSCH is received like this, for example, if random access procedures are executed via a TCC, it is possible to skip receiving a random access preamble and transmitting a random access response. Note that, for the control section 301, a controller, a control circuit or a control device that can be described based on common understanding of the technical field to which the present invention pertains can be used.

The transmission signal generating section 302 generates DL signals based on commands from the control section 301 and outputs these signals to the mapping section 303. For example, the transmission signal generating section 302 generates DL assignments, which report downlink signal allocation information, and UL grants, which report uplink signal allocation information, based on commands from the control section 301. Also, the downlink data signals are subjected to a coding process and a modulation process, based on coding rates and modulation schemes that are determined based on channel state information (CSI) from each user terminal 20 and so on. Note that, for the transmission signal generating section 302, a signal generator, a signal generating circuit or a signal generating device that can be described based on common understanding of the technical field to which the present invention pertains can be used.

The mapping section 303 maps the downlink signals generated in the transmission signal generating section 302 to predetermined radio resources based on commands from the control section 301, and outputs these to the transmitting/receiving sections 103. Note that, for the mapping section 303, mapper, a mapping circuit or a mapping device that can be described based on common understanding of the technical field to which the present invention pertains can be used.

The received signal processing section 304 performs the receiving processes (for example, demapping, demodulation, decoding and so on) of the UL signals that are transmitted from the user terminal (for example, delivery acknowledgement signals (HARQ-ACKs), data signals that are transmitted in the PUSCH, random access preambles that are transmitted in the PRACH, and so on). The processing results are output to the control section 301.

Also, by using the received signals, the received signal processing section 304 may measure the received power (for example, the RSRP (Reference Signal Received Power)), the received quality (for example, the RSRQ (Reference Signal Received Quality)), channel states and so on. The measurement results may be output to the control section 301. Note that a measurement section to perform the measurement operations by using received signals may be provided apart from the received signal processing section 304.

The receiving process section 304 can be constituted by a signal processor, a signal processing circuit or a signal processing device, and a measurer, a measurement circuit or a measurement device that can be described based on common understanding of the technical field to which the present invention pertains.

<User Terminal>

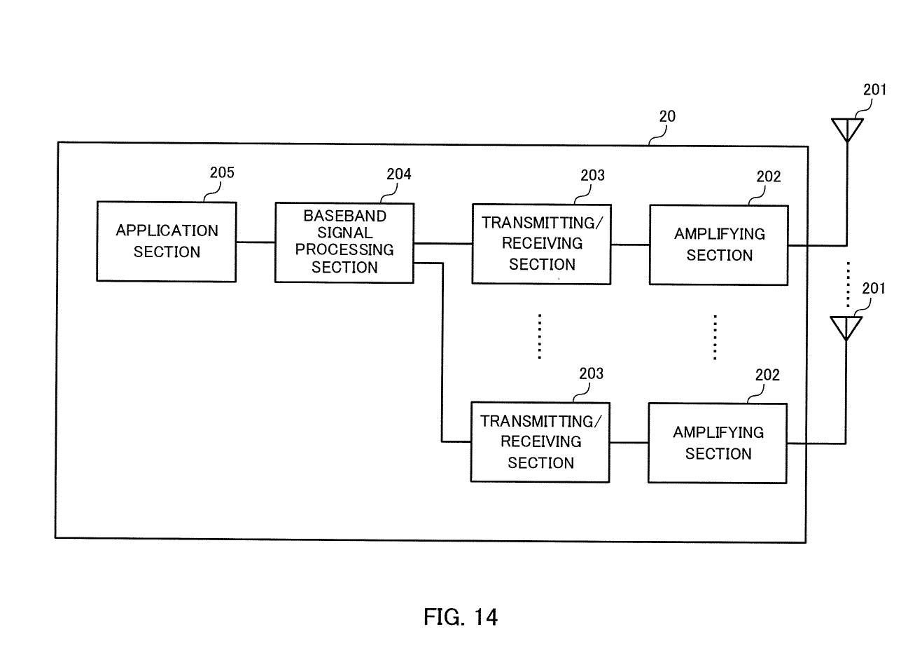

FIG. 14 is a diagram to show an example of an overall structure of a user terminal according to the present embodiment. A user terminal 20 has a plurality of transmitting/receiving antennas 201 for MIMO communication, amplifying sections 202, transmitting/receiving sections 203, a baseband signal processing section 204 and an application section 205. Note that the transmitting/receiving sections 203 may be comprised of transmission sections and receiving sections.

Radio frequency signals that are received in a plurality of transmitting/receiving antennas 201 are each amplified in the amplifying sections 202. Each transmitting/receiving section 203 receives the downlink signals amplified in the amplifying sections 202. The received signals are subjected to frequency conversion and converted into the baseband signal in the transmitting/receiving sections 203, and output to the baseband signal processing section 204.

When random access procedures are executed via a TCC (TCell), the transmitting/receiving sections 203 can transmit identification information for identifying the subject terminal, by using predetermined radio resource, without transmitting a random access preamble. Also, when identification information is transmitted via a TCC, the identification information may be transmitted in each subframe, in one or more consecutive subframes, based on the number of subframes that is determined on a random basis. Note that, for the transmitting/receiving sections 203, transmitters/receivers, transmitting/receiving circuits or transmitting/receiving devices that can be described based on common understanding of the technical field to which the present invention pertains can be used.

In the baseband signal processing section 204, the baseband signal that is input is subjected to an FFT process, error correction decoding, a retransmission control receiving process, and so on. Downlink user data is forwarded to the application section 205. The application section 205 performs processes related to higher layers above the physical layer and the MAC layer, and so on. Furthermore, in the downlink data, broadcast information is also forwarded to the application section 205.

Meanwhile, uplink user data is input from the application section 205 to the baseband signal processing section 204. The baseband signal processing section 204 performs a retransmission control transmission process (for example, an HARQ transmission process), channel coding, pre-coding, a discrete Fourier transform (DFT) process, an IFFT process and so on, and the result is forwarded to each transmitting/receiving section 203. The baseband signal that is output from the baseband signal processing section 204 is converted into a radio frequency band in the transmitting/receiving sections 203. The radio frequency signals that are subjected to frequency conversion in the transmitting/receiving sections 203 are amplified in the amplifying sections 202, and transmitted from the transmitting/receiving antennas 201.

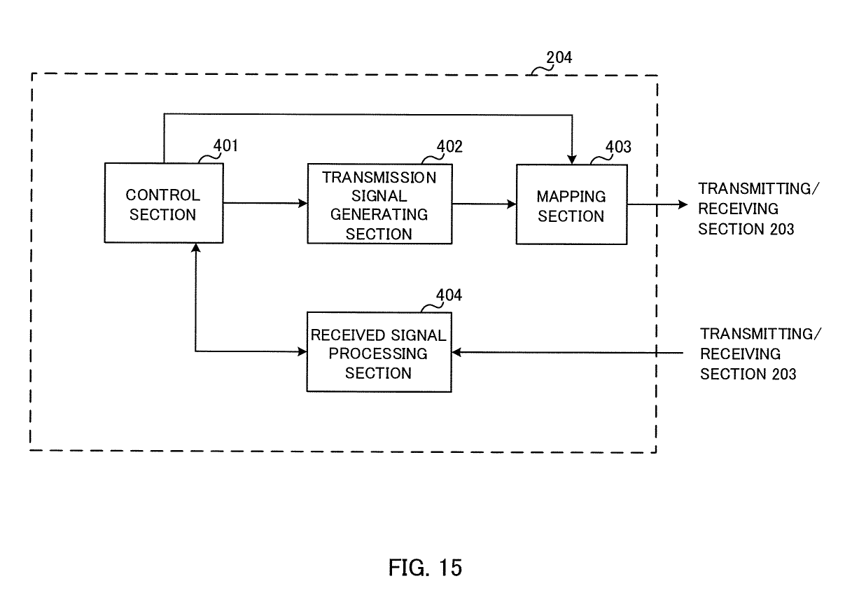

FIG. 15 is a diagram to show an example of a functional structure of a user terminal according to the present embodiment. Note that, although FIG. 15 primarily shows functional blocks that pertain to characteristic parts of the present embodiment, the user terminal 20 has other functional blocks that are necessary for radio communication as well. As shown in FIG. 15, the baseband signal processing section 204 provided in the user terminal 20 has a control section 401, a transmission signal generating section 402, a mapping section 403 and a received signal processing section 404.

The control section 401 acquires the downlink control signals (signals transmitted in the PDCCH/EPDCCH) and downlink data signals (signals transmitted in the PDSCH) transmitted from the radio base station 10, from the received signal processing section 404. The control section 401 controls the generation of uplink control signals (for example, delivery acknowledgement signals (HARQ-ACKs) and so on) and uplink data signals based on the downlink control signals, the results of deciding whether or not retransmission control is necessary for the downlink data signals, and so on.

The control section 401 can control the transmission signal generating section 402, the mapping section 403 and the received signal processing section 404. For example, when the user terminal employs CA that uses TCCs (see FIG. 5 and FIG. 6), the control section 401 applies control so that receiving operations and/or random access operations that are different from those of the PCC and/or SCCs are applied to the TCCs.

According to the above-described first example, when random access procedures are executed via a TCC (TCell), the control section 401 commands the transmission signal generating section 402 and the mapping section 403 to transmit identification information by using predetermined radio resources, without transmitting a random access preamble (see FIG. 8).

Also, according to the above-described second example, when identification information is transmitted via a TCC, the control section 401 can transmit the identification information in each subframe, in one or more consecutive subframes, based on the number of subframes that is determined on a random basis (see FIG. 9 and FIG. 10). Also, when judging that random access has failed, the control section 401 may apply ramping (raise the transmission power) and transmit the identification information again, after the next listening is complete. For the control section 401, a controller, a control circuit or a control device that can be described based on common understanding of the technical field to which the present invention pertains can be used.

The transmission signal generating section 402 generates UL signals based on commands from the control section 401 and outputs these signals to the mapping section 403. For example, the transmission signal generating section 402 generates uplink control signals such as delivery acknowledgement signals (HARQ-ACKs), channel state information (CSI) and so on, based on commands from the control section 401.

Also, the transmission signal generating section 402 generates uplink data signals based on commands from the control section 401. For example, when a UL grant is included in a downlink control signal that is reported from the radio base station 10, the control section 401 commands the transmission signal generating section 402 to generate an uplink data signal. For the transmission signal generating section 402, a signal generator, a signal generating circuit or a signal generating device that can be described based on common understanding of the technical field to which the present invention pertains can be used.

The mapping section 403 maps the uplink signals (uplink control signals and/or uplink data) generated in the transmission signal generating section 402 to radio resources based on commands from the control section 401, and output the result to the transmitting/receiving sections 203. For the mapping section 403, mapper, a mapping circuit or a mapping device that can be described based on common understanding of the technical field to which the present invention pertains can be used.

The received signal processing section 404 performs the receiving processes (for example, demapping, demodulation, decoding and so on) of the DL signals (for example, downlink control signals that are transmitted from the radio base station in the PDCCH/EPDCCH, downlink data signals transmitted in the PDSCH, and so on). The received signal processing section 404 outputs the information received from the radio base station 10, to the control section 401. The received signal processing section 404 outputs, for example, broadcast information, system information, RRC signaling, DCI and so on, to the control section 401.

The received signal processing section 404 can control the DL signal receiving operations based on commands from the control section 401. For example, when a TCC is configured in the user terminal, the received signal processing section 404 can perform receiving operations that are different from those of the PCC and/or SCCs, based on commands from the control section 401 (see FIG. 7). Note that, for the received signal processing section 404, a signal processor/measurer, a signal processing/measurement circuit or a signal processing/measurement device that can be described based on common understanding of the technical field to which the present invention pertains can be used. Also, the received signal processing section 404 can constitute the receiving section according to the present invention.

Note that the block diagrams that have been used to describe the above embodiments show blocks in functional units. These functional blocks (components) may be implemented in arbitrary combinations of hardware and software. Also, the means for implementing each functional block is not particularly limited. That is, each functional block may be implemented with one physically-integrated device, or may be implemented by connecting two physically-separate devices via radio or wire and using these multiple devices.

For example, part or all of the functions of radio base stations 10 and user terminals 20 may be implemented using hardware such as ASICs (Application-Specific Integrated Circuits), PLDs (Programmable Logic Devices), FPGAs (Field Programmable Gate Arrays), and so on. Also, the radio base stations 10 and user terminals 20 may be implemented with a computer device that includes a processor (CPU), a communication interface for connecting with networks, a memory and a computer-readable storage medium that holds programs.

Here, the processor and the memory are connected with a bus for communicating information. Also, the computer-readable recording medium is a storage medium such as, for example, a flexible disk, an opto-magnetic disk, a ROM, an EPROM, a CD-ROM, a RAM, a hard disk and so on. Also, the programs may be transmitted from the network through, for example, electric communication channels. Also, the radio base stations 10 and user terminals 20 may include input devices such as input keys and output devices such as displays.

The functional structures of the radio base stations 10 and user terminals 20 may be implemented with the above-described hardware, may be implemented with software modules that are executed on the processor, or may be implemented with combinations of both. The processor controls the whole of the user terminals by running an operating system. Also, the processor reads programs, software modules and data from the storage medium into the memory, and executes various types of processes. Here, these programs have only to be programs that make a computer execute each operation that has been described with the above embodiments. For example, the control section 401 of the user terminals 20 may be stored in the memory and implemented by a control program that operates on the processor, and other functional blocks may be implemented likewise.

Now, although the present invention has been described in detail above, it should be obvious to a person skilled in the art that the present invention is by no means limited to the embodiments described herein. For example, the above-described embodiments may be used individually or in combinations. The present invention can be implemented with various corrections and in various modifications, without departing from the spirit and scope of the present invention defined by the recitations of claims. Consequently, the description herein is provided only for the purpose of explaining examples, and should by no means be construed to limit the present invention in any way.

The disclosure of Japanese Patent Application No. 2015-030843, filed on Feb. 19, 2015, including the specification, drawings and abstract, is incorporated herein by reference in its entirety.

1. A user terminal that communicates with a radio base station by means of carrier aggregation using a plurality of component carriers (CCs), the user terminal comprising:
a transmission section that transmits UL signals via each CC; and
a control section that controls transmission operations in the transmission section,
wherein, when a plurality of CCs, including at least a first CC, which corresponds to a primary CC of an existing system, and a third CC, which is different from the first CC and a second CC that corresponds to a secondary CC of the existing system, are configured, the control section applies, to the third CC, random access operations that are different from those of the first CC and the second CC.

2. The user terminal according to claim 1, wherein the control section transmits identification information for identifying the user terminal, by using a predetermined radio resource of the third CC, without transmitting a random access preamble.

3. The user terminal according to claim 2, wherein the predetermined radio resource is a resource which the control section selects from a PUSCH (Physical Uplink Shared Channel) area that is configured in advance.

4. The user terminal according to claim 2, wherein the control section transmits the identification information by using the predetermined radio resource in one of a plurality of consecutive subframes.

5. The user terminal according to claim 4, wherein the control section randomly determines the number of subframes for transmitting the identification information.

6. The user terminal according to claim 2, wherein the control section applies ramping to the transmission of the identification information.

7. The user terminal according to claim 2, further comprising a receiving section that receives completion information in response to the transmission of the identification information, from the radio base station.

8. A radio base station that communicates with a user terminal that employs carrier aggregation using a plurality of component carriers (CCs), the radio base station comprising:
a receiving section that receives UL signals from the user terminal;
a transmission section that, when identification of the user terminal is complete, transmits a DL signal that reports completion of identification; and
a control section that controls the receiving section and the transmission section,
wherein, when a plurality of CCs, including at least a first CC, which corresponds to a primary CC of an existing system, and a third CC, which is different from the first CC and a second CC that corresponds to a secondary CC of the existing system, are configured, the control section applies, to the third CC, random access operations that are different from those of the first CC and the second CC.

9. A radio communication method in a user terminal that communicates with a radio base station by means of carrier aggregation using a plurality of component carriers (CCs), the radio communication method comprising the steps of:
transmitting UL signals via each CC; and
controlling transmission operations in the transmission step,
wherein, when a plurality of CCs, including at least a first CC, which corresponds to a primary CC of an existing system, and a third CC, which is different from the first CC and a second CC that corresponds to a secondary CC of the existing system, are configured, random access operations that are different from those of the first CC and the second CC are applied to the third CC.

10. The user terminal according to claim 3, wherein the control section transmits the identification information by using the predetermined radio resource in one of a plurality of consecutive subframes.

11. The user terminal according to claim 10, wherein the control section randomly determines the number of subframes for transmitting the identification information.

12. The user terminal according to claim 3, wherein the control section applies ramping to the transmission of the identification information.

13. The user terminal according to claim 3, further comprising a receiving section that receives completion information in response to the transmission of the identification information, from the radio base station.

14. The user terminal according to claim 4, further comprising a receiving section that receives completion information in response to the transmission of the identification information, from the radio base station.
